(19) United States
(12) Patent Application Publication
(10) Pub. No.: US 2008/0075863 A1
(43) Pub. Date: Mar. 27, 2008

(54) TUNABLE DIELECTRIC COMPOSITIONS AND METHODS

(75) Inventors: Xiaorong Cai, Lexington, KY (US); Michael John Dixon, Richmond, KY (US); Mohanram Jayaram, Sylvania, OH (US); Jeanne Marie Saldanha Singh, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc., Lexington, KY (US)

(21) Appl. No.: 11/834,119

(22) Filed: Aug. 6, 2007

Related U.S. Application Data
(60) Provisional application No. 60/822,528, filed on Aug. 16, 2006.

(51) Int. Cl. H01B 3/20; B05D 3/02

(52) U.S. Cl. 427/372.2; 252/572

(57) ABSTRACT

Methods of timing a printable dielectric layer, dielectric layers made by the method, and devices incorporating the dielectric layers. One such method includes printing a first dielectric composition and a second dielectric composition onto a substrate to provide a mixed composition. The first dielectric composition includes a first concentration of dispersed particles in a carrier fluid and the second dielectric composition includes a polymeric binder component. The mixed composition has a second concentration of particles.

This application claims priority to provisional 60/822,528 filed Aug. 16, 2006, entitled “TUNABLE DIELECTRIC COMPOSITIONS AND METHODS”.

### BACKGROUND AND SUMMARY

Micro-electronic circuits are typically made using expensive deposition, plating and etching technologies. Such technologies typically require significant investments, and clean room atmospheres. It is often time consuming and expensive to make slight variations in components, accordingly, manufacturing lines are often set up for a single application. Additionally, many electronic devices require multi-level wiring or conductors as well as multi-level active and passive devices. In such multi-level constructions, materials having different dielectric constants may he used for different locations or on different levels in the same design layout. It is difficult to provide a wide variety of materials having different dielectric constants in different locations or on different levels using conventional technology. As circuits become more complicated, and require more levels of devices, there continues to be a need for improved and economical manufacturing techniques.

The foregoing and other needs may be provided by a method of tuning a printable dielectric layer, dielectric layers made by the method, and devices incorporating the dielectric layers. One such method includes printing a first dielectric composition and a second dielectric composition onto a substrate to provide a mixed composition. The first dielectric composition includes a first concentration of dispersed particles in a carrier fluid and the second dielectric composition includes a polymeric binder component. The mixed composition has a second concentration of particles.

In another aspect, the disclosure relates to a dielectric layer comprising a cured mixture of a first composition having a first dielectric constant and a second composition having a second dielectric constant different from the first dielectric constant, wherein a ratio of the first composition to the second composition ranges from about 0:1 to about 1:0.

Yet another embodiment of the disclosure provides a method of forming a dielectric layer by micro-fluid jet printing a first composition having an A component of an. A-B curable polymeric layer and a second composition having a B-component of the A-B curable polymeric layer onto a substrate in a ratio of A:B ranging from about 0:1 to about 1:0 in order to provide a curable polymeric layer having a predetermined dielectric constant. The curable polymeric layer is then cored to provide a cured polymeric layer having the predetermined dielectric constant.

The embodiments described herein provide improved techniques for forming dielectric layers that may be varied between layers by simply changing a ratio of a first composition to a second composition printed onto a substrate. Accordingly, multiple layers of dielectric material may be printed to provide dielectric layers for electrical devices without changing or swapping out ejection heads or resorting to more expensive layer deposition techniques. Also, a single layer of dielectric material may be printed onto a substrate wherein the dielectric properties of the layer vary with position on the substrate rather than as a result of thickness variations in the layer.

### BRIEF DESCRIPTION OF THE DRAWINGS

Further advantages of exemplary embodiments disclosed herein may become apparent by reference to the detailed description of exemplary embodiments when considered in conjunction with the drawings, which are not to scale, wherein like reference characters designate like or similar elements throughout the several drawings as follows:

FIG. 1 is a schematic illustration of deposition of a dielectric layer onto a substrate using cartridges containing fluids having different dielectric constants;

FIG. 2 is a graphical representation of dielectric constants versus ratios of titanium dioxide fluid to binder fluid at a single frequency; and

FIGS. 3 and 4 are graphical representations of variations of dielectric constant over a range of frequencies for different ratios of titanium dioxide fluid to binder fluid.

### DETAILED DESCRIPTION OF EXEMPLARY EMBODIMENTS

According to exemplary embodiments of the disclosure, there is provided a method of tuning a printable dielectric layer for an electrical device and compositions suitable for printing dielectric layers having different dielectric properties in each layer. The tunable dielectric layer may be suitably deposited by a plurality of ejection heads (or a single ejection head, as can be understood by one of ordinary skill in the art) for ejecting fluids containing compositions having different dielectric constants. For example, according to a first embodiment of the disclosure, a first composition containing dispersed particles in a carrier fluid having a first dielectric constant may be printed by a first micro-fluid ejection head and a second composition having a second dielectric constant may be printed by a second micro-fluid ejection head.

The two compositions may be printed substantially simultaneously or may be printed one on top of the other provided the two compositions substantially mix and form a film to provide a mixed composition having a third dielectric constant. The first composition typically has a significantly higher dielectric constant than the second composition. Accordingly, the first composition may, for example, have a dielectric constant ranging from about 10 to about 2000 at 1 kHz.

The first composition may include dispersed particles in a carrier fluid providing a first concentration of particles in the fluid having the first dielectric constant. Suitable particles with high dielectric constants that may be used to provide the first composition having the first dielectric constant include strontium titanate, lead zirconate or other fillers that have a high dielectric constant such as those disclosed in U.S. Pat. No. 6,159,611 (Lee) and U.S. Pat. No. 6,586,791. (Lee). Specific examples include BaTiO₃, SrTiO₃, Mg₂TiO₄, Bi₂(TiO₃)₃, PbTiO₃, NiTiO₃, CaTiO₃, ZnTiO₃, Zn₂TiO₄, BaSnO₃, Bi(SnO₃)₃, CaSnO₃, PbSnO₃, PbMgNbO₃, MgSnO₃, SrSnO₃, ZnSnO₃, BaZrO₃, CaZrO₃, PhZrO₃, MgZnO₃, SrZrO₃, and ZnZrO₃. Dense polycrystalline ceramics such as barium titanate and lead zirconate are particularly suitable particles. Other particularly suitable particles include metal oxides such as aluminum, zinc, titanium, and zirconium oxides.

The particulate material used in the first composition may be selected for providing specific physical, optical, or other properties of interest. For example, in situations where transparency is desirable, it may be desirable to choose inorganic particles that are transparent, have a refractive index that matches the matrix material, and/or are small enough that light scattering is minimized. In other embodiments, the particles may be selected for their radiation absorption characteristics.

An advantage of the use of oxide inorganic particles in the first composition is that the particles may provide an improvement in the hardness and abrasion resistance of resulting dielectric layer. Also, suitable selection of an inorganic oxide or oxide mixtures may enable control of the refractive index properties of the layers printed with the first composition.

Typically, when particles are included in a micro-fluid jet printable composition, the composition may include from about 0 up to and including 30 percent by volume inorganic particles or more, based on the total volume of the carrier fluid and inorganic particles.

The particles may be nano-sized particles having a diameter ranging from about 0.5 nanometers to about 3 microns. In some embodiments, the inorganic particles have an average size of 1 to 500 nanometers, while in other embodiments the inorganic particles have an average size of 10 to 250 nanometers, while in yet other embodiments the particles have an average size of 20 to 80 nanometers, or from 10 to 30 nanometers.

Particle size refers to the number average particle size and is measured using an instrument that uses transmission electron microscopy or scanning electron microscopy. Another method to measure particle size is dynamic light scattering, which measures weight average particle size. One example of such an instrument found to be suitable is available from Beekman Coulter, Inc. of Fullerton, Calif. under the trade designation N4 PLUS SUB-MICRON PARTICLE ANALYZER.

The particles of the first composition may be mixed, dispersed, suspended, slurried, or emulsified in a carrier fluid, for example. The carrier fluid may include dispersed particles of the binder that is used in the second compositions and a least one of water and/or at least one organic solvent as may he required to achieve film formation on the substrate. Exemplary organic solvents include glycols (e.g., mono-, di- or tri-ethylene glycols or higher ethylene glycols, propylene glycol, 1,4-butanediol or ethers of such glycols, thiodiglycol), glycerol and ethers and esters thereof, polyglycerol, mono-, di-, and tri-ethanolamine, propanolamine, N,N-dimethylformamide, dimethylsulfoxide, N,N-dimethylacetamide, N-methylpyrrolidone, 1,3-dimethylimidazolidone, methanol, ethanol, isopropanol, n-propanol, diacetone alcohol, acetone, methyl ethyl ketone, propylene carbonate, and combinations thereof. The first composition may also contain one or more optional additives such as, for example, colorants (e.g., dyes and/or pigments), thixotropes, thickeners, surfactants, dispersants, and/or a combination thereof.

Surfactants that may be used to mix, disperse, suspend, slurry or emulsify the particles in an aqueous carrier fluid to provide the first composition may include, but is not limited to, alkylaryl polyether alcohol nonionic surfactants, such as octylphenoxy-polyethoxyethanol available from Dow Chemical Company of Midland, Mich. under the TRITON X series of trade names; alkylamine ethoxylates nonionic surfactants such as from Dow Chemical Company under the TRITON FW series, TRITON CF-10, TERGITOL trade names; ethoxylated acetylenic diol surfactants available from Air Products and Chemicals, Inc. of Allentown, Pa. under the SURFYNOL trade name; polysorbate products available from ICI Chemicals & Polymers Ltd. of Middlesborough, UK under the trade name TWEEN; polyalkylene and polyalkylene modified surfactants Crompton OSI Specialties of Greenwich, Conn., under the trade name SILWET, polydimethylsiloxane copolymers and surfactants available from Crompton OSI Specialties under the trade name COATOSIL; alcohol alkoxylates nonionic surfactants available from Uniqerna of New Castle, Del., under the trade names RENEX, BRIJ, and UKANIL; Sorbitan ester products available from Omya Peralta GmbH of Hamburg, Germany under the trade names SPAN and ARLACEL; alkoxylated esters/polyethylene glycol surfactants available from ICI Chemicals & Polymers Ltd. under the trade names TWEEN, ATLAS, MYRJ and CIRRASOL; alkyl phosphoric acid ester surfactant products such as amyl acid phosphate available from Chemron Corporation of Paso Robles, Calif., under the trade name CHEMPHOS TR-421; alkyl amine oxides available from Chemmron Corporation under the CHEMOXIDE series of surfactant; anionic sarcosinate surfactants available from Hampshire Chemical Corporation of Nashua, N.H. under the HAMPOSYL series of surfactants; glycerol esters or polyglycol ester nonionic surfactants available from Calgene Chemical Inc. of Skokie, Ill. under the HODAG series of surfactants, available from Henkel-Nopco A/S of Drammen, Norway under the trade name ALPHENATE, available from Hoechst AG of Frankfurt, Germany under the trade name SOLEGAL W, and available from Auschem SpA of Milan, Italy under the trade name EMULTEX; polyethylene glycol ether surfactants available from Takemoto Oil and Fact Co. Ltd. of Japan under the trade name NEWKALGEN; modified polydimethyl-silicone surfactants available from BYK Chemie of Wesel, Germany under the BYK 300 series of surfactants; and other commercially available surfactants known to those skilled in the art.

Dispersing agents that may be used to mix, disperse, suspend, slurry or emulsify the particles in an aqueous carrier fluid to provide the first composition may include, but is not limited to, common aqueous-based dye/pigment dispersants such as lignin sulfonates, fatty alcohol polyglycol ethers, and aromatic sulfonic acids, for instance naphthalene sulfonic acids. Some useful dispersants are polymeric acids or bases which act as electrolytes in aqueous solution in the presence of the proper counterions. Such polyelectrolytes provide electrostatic as well as steric stabilization of dispersed particles in an emulsion. Furthermore, such dispersants may supply the ink with charging characteristics in continuous inkjet ink applications. Examples of polyacids include polysaccharides such as polyalginic acid and sodium carboxymethyl cellulose; polyacrylates such as polyacrylic acid, styrene-acrylate copolymers; polysulfonates such as polyvinylsulfonic acid, styrene-sulfonate copolymers; polyphosphates such as polymetaphosphoric acid; polydibasic acids (or hydrolyzed anhydrides), such as styrene-maleic acid copolymers; polytribasic acids such as acrylic acid-maleic acid copolymers. Examples of poly bases include polyamines such as polyvinylamine, polyethyleneimine, poly(4-vinylpyridine); polyquaternary ammonium salts such as poly(4-vinyl-N-dodecyl pyridinium). Amphoteric polyelectrolytes may be obtained by the copolymerization of suitable acidic and basic monomers, for instance, methacrylic acid and vinyl pyridine.

The second composition may include a binder in a solvent or carrier fluid. The binder may be selected from isocyanates, melamines, epoxy binders, acrylic acid esters, and the like. The binder may be suspended, dispersed, slurried, dissolved, or emulsified in a suitable carrier fluid. Aqueous-based systems may be preferred, however, other carrier fluids, including, but not limited to glycols (e.g., mono-, di- or tri-ethylene glycols or higher ethylene glycols, propylene glycol, 1,4-butanediol or ethers of such glycols, thiodiglycol), glycerol and ethers and esters thereof, polyglycerol, mono-, di-, and tri-ethanolamine, propanolamine, N,N-dimethylformamide, dimethylsulfoxide, N,N-dimethylacetamide, N-methylpyrrolidone, 1,3-dimethylimidazolidone, methanol, ethanol, isopropanol, n-propanol, diacetone alcohol, acetone, methyl ethyl ketone, propylene carbonate, and combinations thereof may be used. The amount of binder in the second composition may range from about 0 to about 25% by weight.

As with the first composition, the second composition also has a dielectric constant at a given frequency. However, the second composition desirably has a dielectric constant that is substantially lower than the dielectric constant of the first composition at the same given frequency.

Also, if desired, the second composition may include a photoinitiator to enhance crosslinking. Useful photoinitiators that initiate free radical polymerization may include acryloin and derivatives, thereof, such as benzoin, benzoin methyl ether, benzoin ethyl ether, benzoin isopropyl ether, benzoin isobutyl ether, and (alpha)-methylbenzoin; diketones such as benzil and diacetyl, etc.; organic sulfides such as diphenyl monosulfide, diphenyl disulfide, decyl phenyl sulfide, and tetramethylthiuram monosulfide; S-acyl thiocarbamates such as S-benzoyl-N,N-dimethyldithiocarbamate; and phenones such as acetophenone, henzophenone, and derivatives thereof.

After deposition of the first and second composition, the components of the second composition may be cured or crosslinked using radiation (e.g., ultraviolet (UV), e-beam, gamma) or actinic radiation. Chemical crosslinking agents may also be used in the second composition if desired. Examples of chemical crosslinking agents include, but are not limited to, 1,6-hexanediol di(meth)acrylate, 1,4-butanediol di(meth)acrylate, ethylene di(meth)acrylate, glyceryl di(meth)acrylate, glyceryl tri(meth)acrylate, diallyl phthalate, pentaerythritol triacrylate, dipentaerythritol pentaacrylate, neopentyl glycol triacrylate and 1,3,5-tri(2-methacryloxye-thyl)-s-triazine. Unlike conventional inorganic dielectric processes, it may not be necessary to heat treat the dielectric layers printed according to the disclosed embodiments above about 150° C. in order to obtain desirable dielectric properties.

In another embodiment, a dielectric layer may be provided by selectively depositing a first composition containing an A component of an A-B curable polymeric layer and a second composition containing a B component of the A-B curable polymeric layer. For example, a curable two-party epoxy resin may be printed wherein part A is included in the first composition ejected using a first micro-fluid ejection head and part B is included in the second composition ejected from a second micro-fluid ejection head. By selectively controlling the ratio of the first composition to the second composition over a range of from about 0:1 to about 1:0 to provide a ratio of A:B ranging from about 0:1 to about 1:0, the degree of cross-linking and hence the dielectric properties of the deposited layer may be selected.

The micro-fluid jet printable compositions described herein desirably have a viscosity that permits micro-fluid jet printing. Thus, the first and second compositions may have a viscosity of 1 to 10 centipoise at 25° C. Suitable average ejection head temperatures may include, for example, ejection beads having temperatures of less than or equal to 60° C., although higher temperatures may also be used.

Examples of suitable formulations containing the printable dielectric materials are provided in the following table:

| | | | | | | |
|---|---|---|---|---|---|---|
| | For- | For- | For- | For- | For | For- |
| | mula 1 | mula 2 | mula 3 | mula 4 | mula 5 | mula 6 |
| Component | (wt. %) | (wt. %) | (wt. %) | (wt. %) | (wt. %) | (wt. %) |

| | | | | | | |
|---|---|---|---|---|---|---|
| Acrylic | 3.3 | 15.0 | 5.6 | 9.0 | 12.0 | 15.0 |
| binder | | | | | | |
| TiO₂ | 6.6 | 0.0 | 5.6 | 4.5 | 3.0 | 1.0 |
| Dispersion | | | | | | |
| Surfactant 1 | 2.0 | 2.5 | 2.0 | 2.0 | 2.0 | 2.0 |
| Surfactant 2 | 0.8 | 0.8 | 0.8 | 0.8 | 0.8 | 0.8 |
| Humectant | 15.0 | 15.0 | 15.0 | 15.0 | 15.0 | 15.0 |
| D.I. Water | 72.3 | 66.7 | 71.0 | 68.7 | 67.2 | 66.2 |
| Total | 100 | 100 | 100 | 100 | 100 | 100 |
| TiO₂/binder | 2:1 | 0:1 | 1:1 | 1:2 | 1:4 | 1:15 |
| ratio | | | | | | |

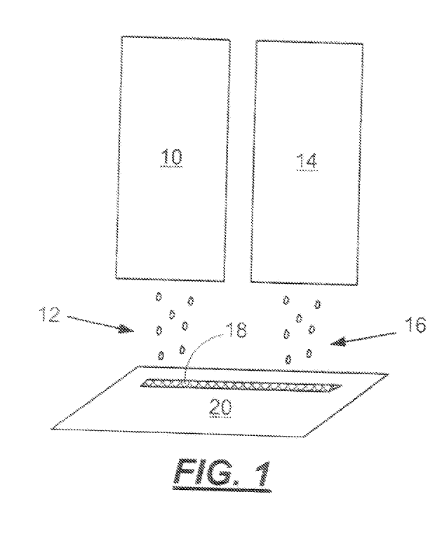

In the foregoing table, “Surfactant 1” was an ethoxylated 2,4,7,9-tetramethyl-5-decyn-4,7-diol surfactant. “Surfactant 2” was a silicon-free alcohol alkoxylate surfactant. The humectant was a propylene glycol. In Formula 1 and Formula 2, a TiO₂ dispersion 12 and binder 16 were ejected individually from ejection cartridges 10 and 14 (FIG. 1) to provide the indicated TiO₂/binder ratios in a layer 18 of dielectric material on a substrate 20 and in Formulas 3-6, the binder and TiO₂ dispersion were mixed to provide the indicated TiO₂/binder ratios and were ejected from a single ejection head to provide the dielectric material layers 18 on the substrate 20. When using a dual ejection cartridges such as ejection cartridges 10 and 14, TiO₂ dispersion 12 and binder 16 may be ejected substantially simultaneously or in succession to provide the layer 18 on the substrate 20 containing a mixture of the binder and dispersion. Multiple depositions of the dispersion 12 and binder 16 may be provided to provide the layer 18. The layer 18 may have an overall thickness ranging from about 5 to about 50 microns, or more. The substrate 20 may he selected from glass, paper, plastic, ceramic, metal, films, circuit, boards, and the like.

A continuum of dielectric layers having different ratios of the dispersion 12 to the binder 16 may be provided by printing from the two ejection cartridges 10 and 14 in predetermined proportions. Control of the proportions printed from ejection heads attached to the cartridges 10 and 14 may selected by using a simple graphic user interface in a design layout tool for a circuit. Different gray scales may also be used to provide layers 18 having different dielectric constants. For example, a pure black layer 18 may correspond to the highest available dielectric constant whereas a light gray layer 18 may correspond to the lowest available dielectric constant that can be provided for the layer 18. Intermediate gray scales may correspond to intermediate dielectric constants for layer 18. An algorithm in software used to print the layer 18 may be used to translate the grayscale selected to a quantity of fluid deposited onto the substrate 20 from each of the cartridges 10 and 14. More than two cartridges containing fluids having different dielectric constants may be used to provide an even wider variety of dielectric layers 18. Hence, embodiments of the disclosure enable printing of high, low, and intermediate dielectric layers 18 without having to change the cartridges or move the substrate 20 to a different deposition station.

One application of the embodiments described herein is the provision of an electroluminescent display wherein different dielectric layers are provided, by varying the grayscale printing of the layers without having to vary the thickness of the dielectric layers. In such an electroluminescent display, a range of illumination levels may be provided using a substantially uniform thickness of the dielectric layer wherein the dielectric properties vary with position in the display.

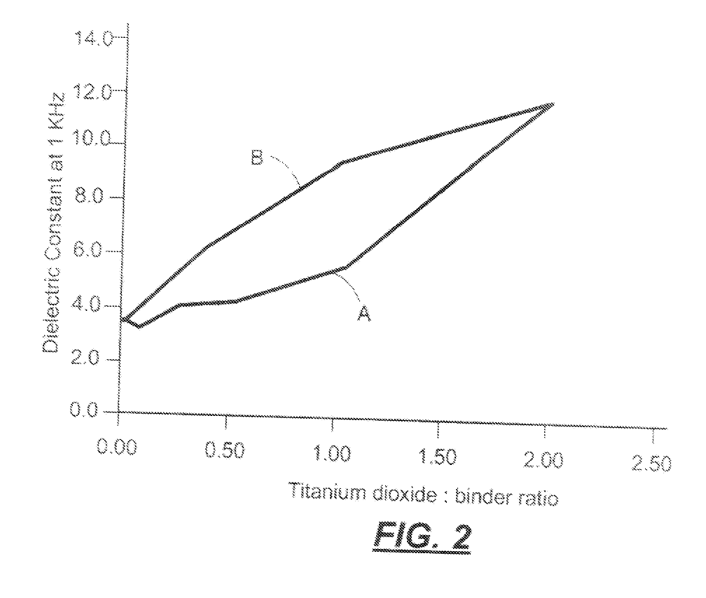

An advantage of exemplary embodiments of the disclosure is that the mixed composition may be printed in a “gray scale” pattern to provide dielectric layers having dielectric constants proportional to the amount of first composition to second composition used. For example, the dielectric constant of the printed layer may be varied by printing a ratio of first composition to second composition ranging from about 0:1 to about 1:0, and all ratios subsumed therein. An illustration of a range of a mixture of dielectric constants that may be printed according to embodiments of the disclosure is illustrated in FIG. 2. In FIG. 2, curve A was printed using a single ejection cartridge containing a mixture of binder and TiO₂ dispersion to provide the indicated ratios. Curve B was printed using two separate ejection cartridges for the binder and dispersion. As shown by Curves A and B in FIG. 2, as the ratio of titanium dioxide composition to binder composition increases, the dielectric of the mixture printed on the substrate 20 also increases.

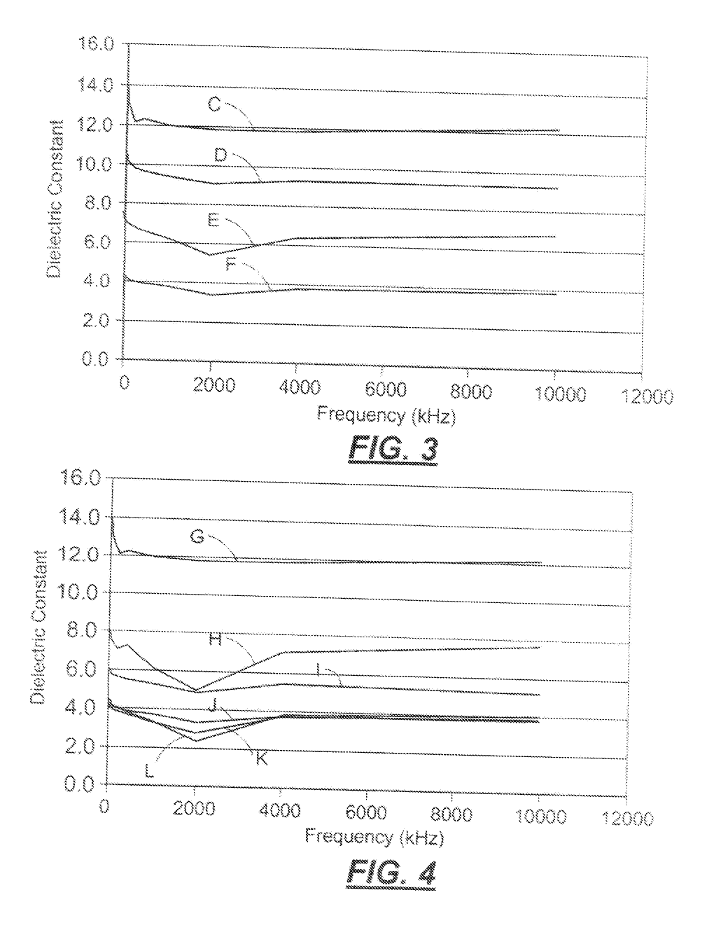

FIGS. 3 and 4 provide illustrations of variation of dielectric constants versus frequencies for layers 18 printed with titanium dioxide to binder ratios of 2:1 (Curves C and G), 0.94:1 (Curve D), 0.36:1 (Curve E), 0:1. (Curves F and K), 1:1 (Curve H), 1:2 (Curve I), 1:4 (Curve J), and 1:15 (Curve L). In FIG. 3, the Curves C-F were generated using two separate fluid cartridges, one containing the TiO₂ dispersion and one containing the acrylic binder. Curves G-L in FIG. 4 were generated by providing the TiO₂ dispersion/acrylic binder ratios in mixtures that were printed by a single fluid cartridge. As shown by the curves, the dielectric constants for dielectric layers 18 printed on a substrate 20 are generally non-variable at higher frequencies (about 4,000 to about 10,000 kHz) for each ratio of TiO₂ dispersion/acrylic binder.

Another advantage of using micro-fluid ejection heads to deposit the first and second compositions on a substrate is that such printing techniques enable dielectric layer to be precisely deposited without potentially damaging or contaminating the substrate. Micro-fluid jet printing is a non-contact printing method, thus allowing insulating or dielectric materials to be printed directly onto substrates without damaging and/or contaminating the substrate surface due to contact, as may occur when using screens or tools and/or wet processing during conventional patterning, depositing, and etching. Micro-fluid jet printing also provides a highly controllable deposition method that may provide precise and consistently applied material to the substrate. Micro-fluid ejection heads for depositing the fluids 12 and 16 may be selected from ejection heads having thermal actuators, piezoelectric actuators, electromagnetic actuators, and the like.

Devices and articles that may be made according to embodiment of the disclosure include transistors, diodes, capacitors (e.g., embedded capacitors), and resistors. The foregoing components may be used in various arrays to form amplifiers, receivers, transmitters, inverters, oscillators, electroluminescent displays and the like.

It is contemplated, and will be apparent to those skilled in the art from the preceding description and the accompanying drawings that modifications and/or changes may be made in the embodiments of the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

1. A method of tuning a printable dielectric layer for an electrical device, the method comprising:
printing a first dielectric composition and a second dielectric composition onto a substrate to provide a mixed composition, the first dielectric composition comprising a first concentration of dispersed particles in a carrier fluid and the second dielectric composition comprising a polymeric binder component, wherein the mixed composition has a second concentration of particles.

2. The method of claim 1, wherein the first composition and the second composition are micro-fluid jet printed onto the substrate.

3. The method of claim 1, wherein the first composition comprises particles selected from the group consisting of metal oxide particles and ceramic particles dispersed in an aqueous carrier fluid.

4. The method of claim 3, wherein the metal oxide comprises a metal oxide selected from the group consisting of titanium dioxide, zirconium dioxide, cerium oxide, silicon dioxide, and aluminum oxide.

5. The method of claim 1, wherein the first composition has a first dielectric constant and the mixed composition has a third dielectric constant intermediate between the first dielectric constant and the second dielectric constant at a given frequency.

6. The method of claim 1, wherein the ceramic particles may be selected from the group consisting of barium titanate and strontium titanate.

7. The method of claim 1, wherein the second composition has a lower dielectric constant than a dielectric constant of the first composition.

8. The method of claim 1, wherein the mixed composition has a ratio of the first composition to the second composition ranging from about 0:1 to about 1:0.

9. The method of claim 8, further comprising printing the first dielectric composition and the second dielectric composition onto a substrate to provide another mixed composition, wherein the other mixed composition has a different ratio of the first composition to the second composition.

10. A dielectric layer comprising a cured mixture of a first composition having a first dielectric constant and a second composition having a second dielectric constant different from the first dielectric constant; wherein a ratio of the first composition to the second composition ranges from about 0:1 to about 1:0.

11. The dielectric layer of claim 10, wherein the first composition comprises particles selected from metal oxide particles and ceramic particles dispersed in an aqueous carrier fluid.

12. The dielectric layer of claim 10, wherein the second composition comprises a polymeric binder in an aqueous carrier fluid.

13. The dielectric layer of claim 10, wherein the first composition comprises titanium dioxide particles dispersed in water.

14. The dielectric layer of claim 13, wherein the first composition further comprises a minor amount of binder.

15. The dielectric layer of claim 10, wherein the second composition comprises an acrylate binder dispersed in water.

16. The dielectric layer of claim 10, wherein the cured mixture comprises a plurality of cured mixtures, wherein the ratio of the first composition to the second composition in each of the cured mixtures is different.

17. The dielectric layer of claim 16, wherein the thickness of the dielectric layer is substantially uniform.

18. A method of forming a dielectric layer, the method comprising:
micro-fluid jet printing a first composition comprising an A component of an A-B curable polymeric layer and a second composition comprising a B-component of the A-B curable polymeric layer onto a substrate in a ratio of A:B ranging from about 0:1 to about 1:0 in order to provide a curable polymeric layer having a predetermined dielectric constant; and
curing the curable polymeric layer to provide a cured polymeric layer having the predetermined dielectric constant.

19. The method of claim 18, wherein the curable polymeric layer comprises a two-part epoxy material.

20. The method of claim 18, further comprising micro-fluid jet printing the first composition and the second composition onto the substrate in another ratio of A:B ranging from about 0:1 to about 1:0 in order to provide the curable polymeric layer with at least two different dielectric constants.
